(19) United States
(12) Patent Application Publication
(10) Pub. No.: US 2016/0319438 A1
(43) Pub. Date: Nov. 3, 2016

(54) SUBSTRATE TREATED WITH COLOR DEVELOPMENT, AND SUBSTRATE COLOR DEVELOPMENT TREATMENT METHOD FOR SAME

(71) Applicant: POSCO, Pohang-si, Gyeongsangbuk-do (KR)

(72) Inventors: Hyunju JEONG, Hwaseong-si (KR); Yeong-Woo JEON, Incheon (KR); Jong-Seog LEE, Incheon (KR); Min Hong SEO, Incheon (KR); Kanghwan AHN, Incheon (KR)

(21) Appl. No.: 15/108,522

(22) PCT Filed: Dec. 26, 2014
(86) PCT No.: PCT/KR2014/012924

§ 371 Date: Jun. 27, 2016

(30) Foreign Application Priority Data
Dec. 26, 2013 (KR) 10-2013-0164044
Dec. 26, 2013 (KR) 10-2013-0164045
Dec. 26, 2013 (KR) 10-2013-0164046
Dec. 26, 2013 (KR) 10-2013-0164047
Dec. 26, 2014 (KR) 10-2014-0190347
Dec. 26, 2014 (KR) 10-2014-0190373

(51) Int. Cl. C23C 22/64; C09D 1/00; C09D 5/08; C23C 22/73; C09D 5/29

(52) U.S. Cl. CPC C23C 22/64; C23C 22/73; C09D 5/29; C09D 5/08; C09D 1/00

(57) ABSTRACT

A substrate treated with color development, according to the present invention is provided with areas on the surface having different temperatures to induce an average thickness difference in the coating, when a coating is formed on a matrix surface containing magnesium, thereby maintaining a metal texture unique to the substrate while enabling the development of several colors on the substrate surface with a single color development treatment, and thus can be useful in areas using magnesium materials, such as external materials for construction, vehicle interiors, and especially in the electrical and electronic parts material fields such as in mobile phone case parts.

### TECHNICAL FIELD

The present invention relates to a color-treated substrate having a surface on which several colors are realized, and a substrate color treatment method therefor.

### BACKGROUND ART

Magnesium is a metal which belongs to lightweight metals among practical metals, has excellent wear resistance, and is very resistant to sunlight and eco-friendly, but has a difficulty in realizing a metal texture and various colors. Further, since it is a metal having the lowest electrochemical performance and is highly active, when a color treatment is not performed thereon, it may be quickly corroded in air or in a solution, and thus has a difficulty in industrial application.

Recently, the magnesium industry has been receiving attention due to the weight reduction trend in overall industry. As exterior materials with a metal texture has become trendy in the field of electrical and electronic component materials such as mobile phone case components, research to resolve the above-described problem of magnesium is being actively carried out.

As a result, Korean Patent Laid-open Publication No. 2011-0016750 disclosed a PVD-sol gel method of performing sol-gel coating after dry coating a surface of a substrate formed of a magnesium alloy with a metal-containing material in order to realize a metal texture and ensure corrosion resistance, and Korean Patent Laid-open Publication No. 2011-0134769 disclosed an anodic oxidation method of imparting gloss to a surface of a substrate including magnesium using chemical polishing and coloring a surface by anodic oxidation of the substrate in an alkaline electrolyte including a pigment dissolved therein.

However, the PVD-sol gel method has a problem in that a texture realized on the surface of the substrate is not the intrinsic texture of magnesium although a metal texture may be realized on the surface of the substrate, and the realization of a variety of colors is difficult. Furthermore, when a color treatment is performed using the anodic oxidation method, there is a problem in that an opaque oxide film is formed on the surface of the substrate, and the realization of the intrinsic texture of metals is not easy.

Accordingly, there is an urgent need for a technique to improve corrosion resistance by chemically, electrochemically or physically treating the surface of the substrate and to realize a desired color on the surface for commercialization of a substrate including magnesium.

### DISCLOSURE

### Technical Problem

An objective of the present invention is to provide a color-treated substrate which includes magnesium and has a surface on which several colors are realized.

Another objective of the present invention is to provide a method of color-treating the substrate.

### Technical Solution

In order to achieve the objectives, one embodiment of the present invention provides a color-treated substrate, including: a matrix including magnesium; and a film formed on the matrix and containing a compound represented by the following Chemical Formula 1:

M(OH)ₘ [Chemical Formula 1]

where M includes one or more selected from the group consisting of Na, K, Mg, Ca and Ba, and m is 1 or 2,

wherein conditions of the following Expressions 1 and 2 are satisfied with respect to an arbitrary point A existing on the matrix:

ΔE₁*<1.0 [Expression 1]

ΔE₂*>2.0 [Expression 1]

where ΔE₁* represents a deviation of average color coordinates of a point A from average color coordinates of an arbitrary point B existing on the same axis, and

ΔE₂* represents a deviation of average color coordinates of a point A from average color coordinates of a point C which is present on a second axis having an average deviation of 75° to 105° from the first axis, is present on the same axis with the average color coordinates of the point A, and is spaced apart a distance of 3 cm or more from the point A.

Further, another embodiment of the present invention provides a method of color-treating a substrate, comprising a step of immersing a matrix including magnesium in a hydroxide solution,

wherein the matrix immersed in the hydroxide solution includes:

an area having a first temperature (T₁); and

an area having a second temperature (T₂),

a difference between the first temperature (T₁) and the second temperature (T₂) is 5° C. or more.

### Advantageous Effects

In the color-treated substrate according to the present invention, an average thickness deviation of a film is induced by forming areas having different temperatures on a surface when the film is formed on a surface of a matrix including magnesium, and thus several colors are realized by a single color treatment. Accordingly, the color-treated substrate according to the present invention may be usefully used in the fields of building exterior materials, automobile interiors, and particularly electrical and electronic component materials, such as mobile phone case components, in which a magnesium material is used.

### DESCRIPTION OF DRAWINGS

FIG. 1 is an image illustrating a color-treated substrate in an embodiment:

Here, a point A is any point existing on a surface of a matrix, a point B is any point existing on the same axis (first axis) with that of the point A, and a point C is a point which is present on a second axis having an average deviation of 75° to 105° from the first axis, is present on the same axis with color coordinates of the point A, and is spaced apart a distance of 3 cm or more from the point A.

FIG. 2 is a cross-sectional view illustrating a structure of a color-treated substrate in an embodiment.

FIG. 3 shows images of measured thicknesses of a film according to immersion time using a transmission electron microscope: Here, A is a substrate of which the immersion time is 10 minutes, B is a substrate of which the immersion time is 170 minutes, and C is a substrate of which the immersion time is 240 minutes.

### MODES OF THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Further, in the drawings of the present invention, the size and relative sizes of layers, regions and/or other elements may be exaggerated or reduced for clarity.

The embodiments of the present invention will be described with reference to the drawings. Throughout the specification, like reference numerals designate like elements and a repetitive description thereof will be omitted.

“Color coordinates”, as used herein, refer to coordinates in a CIE color space, including color values defined by the Commission International de l'Eclairage (CIE), and any position in the CIE color space may be expressed as three coordinate values of L*, a* and b*.

Here, an L* value represents brightness. L*=0 represents a black color, and L*=100 represents a white color. Moreover, an a* value represents whether a color at a corresponding color coordinate leans toward a pure magenta color or a pure green color, and a b* value represents whether a color at a corresponding color coordinate leans toward a pure yellow color or a pure blue color.

Specifically, the a* value ranges from −a to +a, the maximum a* value (a* max) represents a pure magenta color, and the minimum a* value (a* min) represents a pure green color. For example, when an a* value is negative, a color leans toward a pure green color, and when an a* value is positive, a color leans toward pure magenta color. This indicates that, when a*=80 is compared with a*=50, a*=80 represents a color which is closer to a pure magenta color than a*=50. Furthermore, the b* value ranges from −b to +b. The maximum b* value (b* max) represents a pure yellow color, and the minimum b* value (b* min) represents a pure blue color. For example, when a b* value is negative, a color leans toward a pure blue color, and when a b* value is positive, a color leans toward a pure yellow color. This indicates that, when b*=50 is compared with b*=20, b*=80 shows a color which is closer to a pure yellow color than b*=50.

Further, a “color deviation” or a “color coordinate deviation”, as used herein, refers to a distance between two colors in the CIE color space. That is, a longer distance denotes a larger difference in color, and a shorter distance denotes a smaller difference in color, and this may be expressed by ΔE* represented by the following Expression 6:

ΔE*=\sqrt{(ΔL*)²+(Δα*)²+(Δb*)²} [Expression 6]

Furthermore, a “wavelength conversion layer”, as used herein, refers to a layer for controlling a wavelength of incident light by adjusting reflection, refraction, scattering, diffraction or the like of light, which may serve to minimize additional refraction and scattering, in a top coat, of light refracted and scattered in a film, and maintain a color developed by the layer by inducing light reflection.

Lastly, a unit “T”, as used herein, represents a thickness of a substrate including magnesium, and is the same as a unit “mm”.

The present invention provides a color-treated substrate having a surface on which several colors are realized and a substrate color treatment method therefor.

A PVD-sol gel method, an anodic oxidation method or the like, which is a method of coating a surface of a material with a metal-containing material, a pigment or the like, has been conventionally known as a method for realizing a color on the material including magnesium. However, these methods may cause a reduction in durability of the substrate. Further, it is difficult to realize a uniform color on the surface of the material, and there is a problem of unmet reliability because a coated film layer is easily detached. Particularly, the intrinsic texture of metals is not realized in these methods are impossible, and thus, they are difficult to be applied in the fields of building exterior materials, automobile interiors, and particularly electrical and electronic component materials, such as mobile phone case components.

In order to address these issues, the present invention suggests

In order to overcome these problems, the present invention proposes a substrate which is color-treated to realize several colors, and a substrate color treatment method therefor. The color-treated substrate according to the present invention is advantageous in that an average thickness deviation of a film is induced by forming areas having different temperatures on a surface when a film is formed on a surface of a matrix including magnesium, and thus several colors like a rainbow are realized by a single color treatment.

Hereinafter, the present invention will be described in further detail.

An embodiment of the present invention provides a color-treated substrate, including: a matrix including magnesium; and a film formed on the matrix and containing a compound represented by the following Chemical Formula 1:

M(OH)ₘ [Chemical Formula 1]

where M includes one or more selected from the group consisting of Na, K, Mg, Ca and Ba, and m is 1 or 2,

wherein conditions of the following Expressions 1 and 2 are satisfied with respect to an arbitrary point A existing on the matrix:

ΔE₁*<1.0 [Expression 1]

ΔE₂*>2.0 [Expression 2]

where ΔE₁* represents a deviation of average color coordinates of the point A from average color coordinates of an arbitrary point B existing on the same axis, and

ΔE₂* represents a deviation of average color coordinates of the point A from average color coordinates of a point C which is present on a second axis having an average deviation of 75° to 105° from the first axis, is present on the same axis with the average color coordinates of the point A, and is spaced apart a distance of 3 cm or more from the point A.

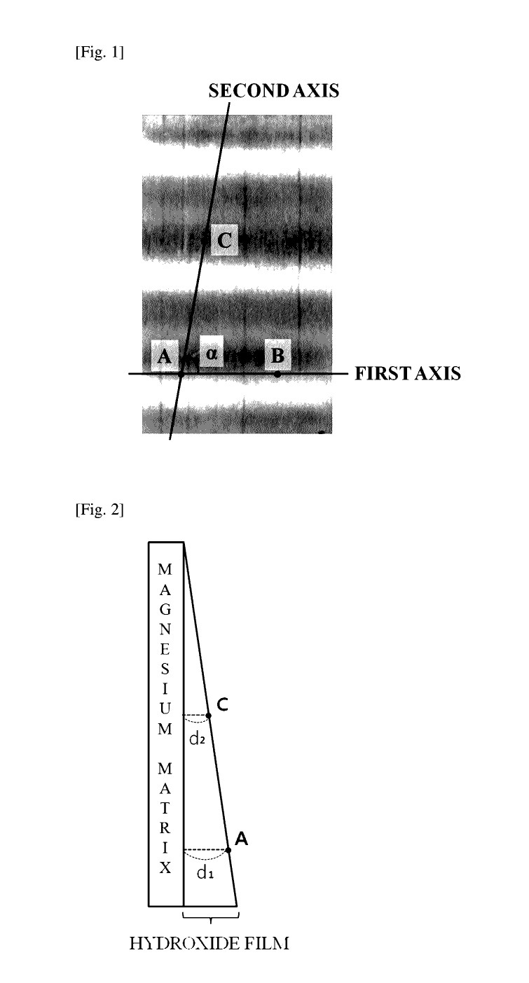

FIG. 1 is an image illustrating a color-treated substrate in an embodiment.

Referring to FIG. 1, the average color coordinate deviation of the arbitrary point B existing on the first axis may satisfy a condition of ΔE₁*<1.0 with respect to the arbitrary point A existing on the matrix including magnesium. Here, ΔE₁* of less than 1.0 indicates that the same color is uniformly developed at the point A and the point B.

Further, the average color coordinate deviation of the point C, which is present on a second axis having a deviation (α) of 75° to 105° from the first axis, is present on the same axis with the average color coordinates of the point A, and is spaced apart a distance of 3 cm or more from the point A, may satisfy a condition of ΔE₂*>2.0, and specifically may satisfy a condition of ΔE₂*>2.5. Here, the exceedance of ΔE₂* indicates that different colors are developed at each of the point A and the point C, and the larger the distance between the point A and the point C is, the larger the average color coordinate deviation may be (refer to Experimental Example 3).

Further, in the color-treated substrate according to the present invention, a deviation of a film average thickness of an arbitrary point A existing on the matrix including magnesium from a film average thickness of a point C existing on the second axis satisfies a condition of the following Expression 3:

10 nm≦|d₁−d₂| [Expression 3]

where d₁ represents a film average thickness of a point A, and d₂ represents a film average thickness of a point B.

FIG. 2 is a cross-sectional view illustrating a structure of a color-treated substrate in an embodiment.

Referring to FIG. 2, a film is formed on the matrix including magnesium, the formed film has a structure in which a thickness is gradually increasing or decreasing, and does not have a structure in which the thickness is constant, and thus may have a thickness deviation according to the position and distance of any two points. That is, a film average thickness (d₁) of an arbitrary point A on the matrix and the film average thickness (d₂) of a point C existing on the second axis may have a thickness deviation. At the two points, the larger the thickness deviation is, the larger the average color coordinate deviation may be. Here, the average color coordinate deviation may be 10 nm or more.

Here, an average thickness of the film may be specifically in the range of 50 nm to 2 μm, and more specifically, in the range of 100 nm to 1 μm, but is not particularly limited thereto.

Here, a material of the film is not particularly limited as long as the film may scatter and refract the light incident to the surface. Specifically, the material of the film may include one or more of sodium hydroxide (NaOH), potassium hydroxide (KOH), magnesium hydroxide (Mg(OH)₂), calcium hydroxide (Ca(OH)₂) and barium hydroxide (Ba(OH)₂), and more specifically, may include magnesium hydroxide (Mg(OH)₂).

In an embodiment, X-ray diffraction analysis was performed on the film included in the color-treated substrate. As a result, the film was determined to have 20 diffraction peak values of 18.5±1.0°, 38.0±1.0°, 50.5±1.0°, 58.5±1.0°, 62.0±1.0° and 68.5±1.0°. This indicates that the film formed on the surface of the substrate is formed of magnesium hydroxide (Mg(OH)₂) having a brucite crystalline structure. As can be seen from the results, the color-treated substrate according to the present invention includes magnesium hydroxide (Mg(OH)₂) (refer to Experimental Example 2).

Moreover, the matrix may be the same as a substrate before being subject to a color treatment. Any material may be used as the matrix as long as the material includes magnesium and is usable as a frame in the fields of electrical and electronic component materials, and the type or form of the matrix is not particularly limited. As an example, a magnesium substrate formed of magnesium; a stainless steel or titanium (Ti) substrate of which surface has magnesium dispersed therein or the like may be used.

Further, the color-treated substrate according to the present invention may further include a wavelength conversion layer formed on the film, and a top coat formed on the wavelength conversion layer.

Here, the type or form of the wavelength conversion layer is not particularly limited as long as the wavelength conversion layer may minimize additional refraction and scattering, in the top coat, of light refracted and/or scattered in the film, and maintain a color developed by the layer by inducing light reflection. Specifically, the wavelength conversion layer may include one or more selected from the group consisting of metals including aluminum (Al), chromium (Cr), titanium (Ti), gold (Au), molybdenum (Mo), silver (Ag), manganese (Mn), zirconium (Zr), palladium (Pd), platinum (Pt), cobalt (Co), cadmium (Cd) or copper (Cu) and ions thereof, and specifically, may include chromium (Cr). Further, the metals may be in the form of metal particles, and may include various types such as a metal nitride, a metal oxide, a metal carbide or the like by reacting with a nitrogen gas, an ethane gas, an oxygen gas and the like in the process of forming the wavelength conversion layer. Moreover, the wavelength conversion layer may be a continuous layer in which the metals are densely stacked on the film and fully cover the surface of the film, or a discontinuous layer in which the metals are dispersed on the film, but is not limited thereto.

Further, an average thickness of the wavelength conversion layer is not particularly limited as long as discoloration of a color developed by the film may be prevented. Specifically, the average thickness may satisfy a condition of 5 nm to 200 nm More specifically, the average thickness may be in the range of 5 to 150 nm, 10 to 100 nm, 5 to 20 nm, 10 to 15 nm, 20 to 40 nm, 10 to 30 nm, or 30 to 50 nm

The top coat may be further included in order to improve scratch resistance and durability of the surface of the substrate including magnesium. Here, a clear coating agent for forming the top coat is not particularly limited as long as it is a clear coating agent which is applicable to metal coatings. More specifically, a matte clear coating agent or a glossy/matte clear coating agent which is applicable to metal coatings or the like may be exemplified.

Further, when the color-treated substrate including the top coat is sprayed with 5 wt % salt water at 35° C. and the adhesiveness thereof was evaluated after 72 hours, it may have a peel rate of the top coat of 5% or less.

In an embodiment, the color-treated substrate having a matte or glossy/matte top coat formed thereon was sprayed with 5 wt % salt water at 35° C. and was tested by a cross-cut tape test method after 72 hours. As a result, it was determined that the area of the detached top coat was 5% or less with respect to the total area of the sample. As can be seen from the results, the substrate having the top coat formed thereon according to the present invention has excellent adhesiveness between the color-treated substrate and the top coat (refer to Experimental Example 4).

Another embodiment of the present invention provides a method of color-treating a substrate, comprising a step of immersing a matrix including magnesium in a hydroxide solution,

wherein the matrix immersed in the hydroxide solution includes:

an area having a first temperature (T₁); and

an area having a second temperature (T₂),

a difference between the first temperature (T₁) and the second temperature (T₂) is 5° C. or more.

The method of color-treating the substrate according to the present invention may be performed by immersing the matrix including magnesium in the hydroxide solution to form a film, and may form areas having different temperatures on the matrix when immersing in the hydroxide solution such that an average thickness deviation of the film is induced. That is, an average temperature difference between the first temperature (T₁) and the second temperature (T₂) having different temperatures may be 5° C. or more, and specifically, may be 10° C. or more. For example, the temperature difference may be 60° C. or less.

For example, a container containing a 10 wt % NaOH solution at 100° C. is installed at a heating reactor of which a surface is heated to 150° C., and the bottom of the container may be controlled to have a temperature of 150° C. by hot wires of the heating reactor. Then, a sample (4 cm width×7 cm length) which is a matrix including magnesium may be immersed once to contact the bottom of the container for 80 minutes. Here, the surface of the matrix may have a temperature area in which a surface temperature is gradually increased from the point farthest from the bottom of the container to the point contacting the bottom of the container, while being immersed in the NaOH solution and maintaining a surface temperature of at least 100° C.

Further, the first temperature (T₁) and the second temperature (T₂) each independently may be 95° C. or more. Specifically, a method of color treating in the state in which a heat source at 100° C. or more is adjacent to a side of the matrix while an average temperature of a hydroxide solution is controlled to 100° C. or less may be applicable.

Here, the first temperature (T₁) and the second temperature (T₂) are not particularly limited as long as the development of various colors may be realized by a temperature difference. Specifically, the first temperature (T₁) may range from 95 to 100° C., from 98 to 105° C. or from 100 to 115° C. Further, the second temperature (T₂) may range from 100 to 115° C., from 105 to 120° C., or from 105 to 150° C.

Here, any solution including a hydroxyl group (—OH group) may be used as the hydroxide solution, without particular limitation. Specifically, a solution having one or more selected from the group consisting of NaOH, KOH, Mg(OH)₂, Ca(OH)₂ and Ba(OH)₂ dissolved therein may be used.

In an embodiment, the coloring speed, the coloring power and the color uniformity of the matrix including magnesium were evaluated. As a result, when a solution in which NaOH had been dissolved was used as a hydroxide, it was confirmed that the coloring speed thereof is four times faster as compared to that of the case in which distilled water was used. Further, it was determined that the coloring power of the color developed on the surface is excellent, and a uniform color is realized. As can be seen from the results, when a solution in which a metal hydroxide such as NaOH or the like is dissolved is used as a hydroxide solution, the film is uniformly formed on the surface of the matrix in a short time, and thus a color may be realized by excellent coloring power (refer to Experimental Example 1).

Further, the preparation method according to the present invention may control the thickness of the film formed on the surface of the matrix according to immersion conditions. Here, since the amount of heat conduction of the matrix varies depending on the thickness of the matrix, when the thicknesses of the matrices are different, the thickness of the films formed on matrices may be different even though the matrices were immersed under the same conditions. Accordingly, it is preferable to control the thickness of the film by adjusting immersion conditions according to the thickness of the matrix including magnesium.

As an example, when the thickness of the matrix including magnesium is in the range of 0.4 to 0.7 T, the concentration of the hydroxide solution may range from 1 to 80 wt %, and more specifically, from 1 to 70 wt %; 5 to 50 wt %; 10 to 20 wt %; 1 to 40 wt %; 30 to 60 wt %; 15 to 45 wt %; or 5 to 20 wt %. Further, the immersion time may be in the range of 1 to 500 minutes, and specifically, in the range of 10 to 90 minutes. In the present invention, various colors may be economically realized on the surface of the substrate and a decrease in the intrinsic glossiness of the substrate due to an excessively increased thickness of the film may be prevented within the above-described ranges.

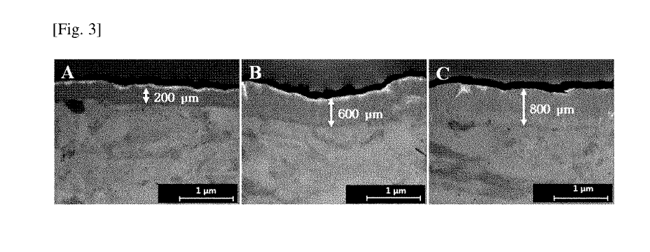

Referring to FIG. 3, it can be confirmed that the average thickness of the film formed on the surface of the substrate increases as the immersion time of the matrix passes, and a color developed on the surface is changed accordingly. This indicates that the color realized on the surface is changed according to the thickness of the film. Therefore, it can be seen that the color realized on the surface of the substrate may be adjusted by controlling the concentration and temperature of the hydroxide solution for immersing the matrix and the immersion time (refer to Experimental Example 2).

Moreover, in the method of color-treating the substrate according to the present invention, the step of immersing in the hydroxide solution may include: a first immersion step of immersing in a hydroxide solution with a concentration of N₁; and a n^{th} immersion step of immersing in a hydroxide solution with a concentration of Nₙ, and the first immersion step and the n^{th} immersion step may be carried out using a method in which the concentration of the hydroxide solution satisfies the following Expressions 3 and 4 independently of each other, and n is an integer of 2 or more and 6 or less:

8≦N₁≦25 [Expression 3]

Nₙ₋₁Nₙ|>3 [Expression 4]

where N₁ and Nₙ represent a concentration of a hydroxide solution in each step, and have units of wt %.

As described above, the step of immersing in the hydroxide solution is a step of realizing a color by forming a film on the surface of the substrate including magnesium, and the developed color may be controlled by adjusting the thickness of the formed film. Here, since the thickness of the film may be controlled according to the concentration of the hydroxide solution, when the concentration of the hydroxide solution for immersing the matrix is divided into N₁ to Nₙ, and specifically, N₁ to N₆; N₁ to N₅; N₁ to N₄; N₁ to N₃; or N₁ to N₂; and the matrix is sequentially immersed therein, minute differences in the color realized on the surface may be controlled.

Further, the method of color-treating the substrate according to the present invention substrate may further include one or more steps of: pretreating a surface before the step of immersing in the hydroxide solution; rinsing after the step of immersing in the hydroxide solution; and forming a wavelength conversion layer after the step of immersing in the hydroxide solution.

Here, the step of pretreating the surface is a step of eliminating contaminants remaining on the surface by treating the surface using an alkaline cleaning solution or grinding the surface before forming the film on the matrix. Here, the alkaline cleaning solution is not particularly limited as long as the solution is generally used to clean a surface of metals, metal oxides or metal hydroxides in the related field. Further, the grinding may be performed by buffing, polishing, blasting, electrolytic polishing or the like, but is not limited thereto. In the present step, not only contaminants or scale which is present on the surface of the matrix including magnesium may be removed, but also the speed of forming the film may be controlled by surface energy of the surface and/or surface conditions, specifically microstructural changes of the surface. That is, the thickness of the film formed on the polished matrix may be different from that of the film formed on the unpolished matrix even though the film is formed on the polished matrix under the same conditions as the film of the unpolished matrix, and each color developed on the surface may be different accordingly.

Further, the step of rinsing is a step of eliminating any hydroxide solution remaining on the surface by rinsing the surface of the matrix after forming the film on the matrix, specifically after the step of immersing the matrix in the hydroxide solution. In this step, additional formation of the film due to any remaining hydroxide solution may be prevented by removing the hydroxide solution remaining on the surface of the matrix.

Moreover, the step of forming the wavelength conversion layer is a step of preventing discoloration of a color developed by a film due to a top coat by forming a wavelength conversion layer on the film when the top coat is formed in order to improve scratch resistance and durability of the surface of the substrate including magnesium. Here, the wavelength conversion layer may be formed by a method which is generally used to form a wavelength conversion layer in the related field. Specifically, it may be formed by a method such as vacuum deposition, sputtering, ion plating, ion beam deposition or the like. Furthermore, a material of the wavelength conversion layer is not particularly limited as long as the material may maintain a color developed by the film by minimizing re-refraction and re-scattering of the light developed by the top coat and reflecting the light. As an example, the wavelength conversion layer may include one or more selected from the group consisting of metals including aluminum (Al), chromium (Cr), titanium (Ti), gold (Au), molybdenum (Mo), silver (Ag), manganese (Mn), zirconium (Zr), palladium (Pd), platinum (Pt), cobalt (Co), cadmium (Cd) or copper (Cu) and ions thereof.

### MODE FOR THE INVENTION

Hereinafter, the present invention will be described in further detail with reference to examples and experimental examples.

However, the following examples and experimental examples are for illustrative purposes only and not intended to limit the scope of the present invention.

### EXAMPLE 1

A sample prepared as a matrix including magnesium with a size of 4 cm×7 cm×0.4 T was degreased by immersing in an alkaline cleaning solution. Then, a container containing a 10 wt % NaOH solution at 100° C. was installed at a heating reactor of which a surface was heated to 150° C., and the bottom of the container was controlled to have a temperature of 150° C. by hot wires of the heating reactor. The degreased sample was immersed once in the container such that a horizontal surface of the sample contacted the bottom of the container for 80 minutes, the sample was rinsed using distilled water, and was dried to prepare a color-treated sample.

When the sample was observed with the naked eye, it was determined that the surface of the sample was sequentially colored to have a magenta color, a yellow color, a green color and so forth, like a rainbow.

### EXAMPLE 2

A color-treated sample was prepared in the same manner as in Example 1. Thereafter, matte clear coating was performed on the sample, and thereby a color-treated sample having a matte top coat formed thereon was prepared. Here, a thickness of a matte clear coating layer was 5 μm or less.

### EXAMPLE 3

A color-treated sample was prepared in the same manner as in Example 1. Thereafter, glossy/matte clear coating was performed on the sample, and thereby a color-treated sample having a glossy/matte top coat formed thereon was prepared. Here, a thickness of a glossy/matte clear coating layer was 5 μm or less.

### EXPERIMENTAL EXAMPLE 1

### Evaluation of Coloring Efficiency of Substrate According to Type of Hydroxide Solution

In order to evaluate a coloring speed and the coloring power of a color-treated substrate according to a type of a hydroxide solution, the following experiment was performed.

Magnesium-containing samples with a size of 1 cm×1 cm×0.4 T were degreased by immersing in an alkaline cleaning solution, and the degreased samples were respectively immersed in a 10 wt % NaOH solution at 100° C. for 40 minutes, 1 hour and 2 hours. Thereafter, the sample was rinsed using distilled water and dried in a drying oven, and colors developed on the surface were evaluated with the naked eye.

As a result, it was determined that the sample prepared by immersing in a 10 wt % NaOH solution has a higher coloring speed than that of a sample prepared by immersing in distilled water as a hydroxide solution. More specifically, the sample prepared by immersing in a 10 wt % NaOH solution was colored to have a silver color after 10 minutes of immersion, and changed to a yellow color, and then colored to have an orange color within 40 minutes of immersion. However, in the case of the sample in which the immersion time was 40 minutes, it was determined that a color change amount of the surface was slight and a color difference was not so large as compared to a non-color-treated substrate. Furthermore, it was determined that the sample in which the immersion time was 1 hour was gradually colored to have a yellow color, and the sample in which the immersion time was 2 hours was colored to have a yellow color, but the coloring power of the developed color was significantly lower than that of the sample prepared by immersing in a 10 wt % NaOH solution.

From these results, it can be seen that the color treatment of the substrate performed using a hydroxide solution including NaOH, KOH, Mg(OH)₂, Ca(OH)₂, Ba(OH)₂ or the like, has high efficiency and the color developed therefrom is also uniform.

### EXPERIMENTAL EXAMPLE 2

### Evaluation of Coloring of Substrate According to Hydroxide Solution Immersion Time

In order to evaluate the degree of coloring of the substrate including magnesium according to an immersion time, the following experiment was performed.

A magnesium-containing sample with a size of 1 cm×1 cm×0.4 T was degreased by immersing in an alkaline cleaning solution, and the degreased sample was immersed in a 10 wt % NaOH solution at 100° C. for 240 minutes. Here, a developed color was observed with the naked eye at intervals of 5 to 10 minutes immediately after the sample was immersed in the NaOH solution. Further, X-ray diffraction analysis and transmission electron microscope (TEM) imaging of the film was performed on the sample after 10 minutes, 170 minutes and 240 minutes of immersion in order to determine the component and thickness of the film formed on the surface of the sample. The result is shown in FIG. 3.

The color-treated substrate according to the present invention was determined to have a developed color varying according to the time of immersion in the hydroxide solution. More specifically, when the non-color-treated sample having a silver color is immersed in the hydroxide solution, it was determined that yellow, orange, red, purple, blue and green colors were sequentially developed after 30 minutes of immersion, and this color change becomes repeated at a predetermined interval over time.

Further, as a result of performing X-ray diffraction analysis on the films of the samples after 10 minutes, 170 minutes and 240 minutes of immersion in a 10 wt % NaOH solution, all the films of three samples were determined to have 20 diffraction peak values of 18.5±1.0°, 38.0±1.0°, 50.5±1.0°, 58.5±1.0°, 62.0±1.0° and 68.5±1.0°, and were confirmed to include magnesium hydroxide (Mg(OH)₂) having a brucite crystalline structure.

Moreover, as can be seen from FIG. 3, the average thickness of the film is increased to about 200 nm, 600 nm and 900 nm as each immersion time has passed.

From these results, it can be seen that the color-treated substrate according to the present invention realizes coloring by including the film containing magnesium hydroxide (Mg(OH)₂). Further, the thickness of the film formed on the surface may be controlled according to the immersion time of the substrate including magnesium, and the color developed therefrom may be controlled.

### EXPERIMENTAL EXAMPLE 3

### Evaluation of Developed Color of Color-Treated Substrate

In order to evaluate the uniformity and diversity of the color-treated substrate according to the present invention, the following experiment was performed.

An arbitrary point A existing on the sample prepared according to Example 1 was set, and color coordinates (L*, a*, b*) in a CIE color space with respect to the point A were measured. Further, as shown in FIG. 1, an arbitrary point B existing on the first axis with respect to the point A was set, and color coordinates of the point B were measured. Thereafter, a point C, which is present on a second axis having an average deviation (α) of 75° to 105° from the first axis, is present on the same axis with color coordinates of the point A, and is spaced apart a distance of 3 cm or more from the point A, was set, and color coordinates of the point C were measured. A deviation of the average color coordinates of the measured three points was measured to evaluate the uniformity and diversity of colors developed in the surface of the substrate, and the result is shown in Table 1.

TABLE 1

| Arbitrary | | | | | | | |
|---|---|---|---|---|---|---|---|
| points | L* | a* | b* | ΔL* | Δa* | Δb* | ΔE* |
| A | 47.66 | 7.67 | −1.88 | — | — | — | — |
| B | 47.61 | 8.02 | −1.42 | 0.05 | −0.35 | −0.46667 | 0.58547227 |
| C | 53.75 | −7.35 | 10.71 | 6.09 | 15.02 | 12.59 | 20.523075 |

As can be seen in Table 1, the color-treated substrate according to the present invention may realize several colors on the surface of magnesium by a single color treatment, and the color uniformity of the same color is excellent.

More specifically, an average color coordinate deviation (ΔE₁*) of the point A existing on the magnesium sample color-treated in Example 1 and the arbitrary point B existing on the first axis with respect to the point A was 0.585, which satisfies a condition of ΔE₁*<1.0. Further, an average color coordinate deviation (ΔE₂*) of the point C, which is present on a second axis having an average deviation (α) of 75° to 105° from the first axis, is present on the same axis with color coordinates of the point A, and is spaced apart a distance of 3 cm or more from the point A, was 20.523, which satisfies a condition of ΔE₂*>2.0. This indicates that the same color is uniformly developed at the point B and the point A, and a color which is completely different from that of the point A is developed at the point C.

Referring to FIG. 1 illustrating the sample of Example 1, the sample is immersed such that a horizontal surface of the sample contacts the bottom of the container at 150° C., and discoloration occurs based on an area of the sample contacting the bottom of the container to develop a color. That is, the point A and point B of a film are formed at the same temperature on the matrix including magnesium has a very low average thickness deviation of a film on which a color is developed, and thus are capable of developing the same color satisfying a condition of ΔE₁*<1.0. On the other hand, in the case of the point C having a difference of a film forming temperature of 5° C. or more from the point A, it may be determined that a completely different color satisfying a condition of ΔE₂*>2.0 is developed due to an average thickness deviation of about 10 nm or more of the film.

From this, it can be seen that the color-treated substrate according to the present invention forms areas having different temperatures on the surface of the matrix when a film is formed on the color-treated substrate, and induces an average thickness deviation of the film, and thereby realizes several colors on the surface of magnesium by a single color treatment.

### EXPERIMENTAL EXAMPLE 4

### Evaluation of Physical Properties of Color-Treated Substrate Having Top Coat Formed Thereon

In order to evaluate corrosion resistance and adhesiveness of the color-treated substrate having a top coat formed thereon, the following experiment was performed.

The experiment was performed on the color-treated sample having a top coat formed thereon in Example 2, and the surface corrosion resistance; and the adhesiveness between the color-treated substrate and the top coat formed on the surface of the sample were evaluated after 72 hours of spraying salt water. Here, the adhesiveness was evaluated using a cross-cut tape test method. More specifically, the adhesiveness was evaluated using a method, in which a coated top coat was cut to have 6 vertical cuts and 6 horizontal cuts intersecting one another and formed at 1 mm intervals using a knife, the tape was firmly attached to the intersection points of the vertical cuts and horizontal cuts, and the area of the top coat which is peeled when the tape was quickly detached with respect to the total area of the sample was measured.

As a result, it can be seen that the color-treated substrate having the top coat formed thereon according to the present invention has excellent corrosion resistance, and outstanding adhesiveness between the color-treated substrate and the top coat. More specifically, it was determined that no deformation of the surface due to corrosion occurred in the case of the sample having a matte top coat formed thereon in Example 2. Further, as a result of evaluating the adhesiveness of the sample on which a corrosion resistance test was performed, it was determined that the area of the top coat which is peeled due to the tape is 5% or less based on the total area of the top coat.

From these results, it can be seen that the color-treated substrate having a top coat formed thereon according to the present invention has excellent corrosion resistance as well as outstanding adhesiveness between the color-treated substrate and the top coat.

### INDUSTRIAL APPLICABILITY

In the color-treated substrate according to the present invention induces an average thickness deviation of a film is induced by forming areas having different temperatures on a surface when the film is formed on a surface of a matrix including magnesium, and thus several colors are realized by a single color treatment. Accordingly, the color-treated substrate according to the present invention can be usefully used in the fields of building exterior materials, automobile interiors, and particularly electrical and electronic component materials, such as mobile phone case components, in which a magnesium material is used.

1. A color-treated substrate, comprising: a matrix including magnesium; and a film formed on the matrix and containing a compound represented by the following Chemical Formula 1:
M(OH)ₘ [Chemical Formula 1]
where M includes one or more selected from the group consisting of Na, K, Mg, Ca and Ba, and m is 1 or 2,
wherein conditions of the following Expressions 1 and 2 are satisfied with respect to an arbitrary point A existing on the matrix:
ΔE₁*<1.0 [Expression 1]
ΔE₂*>2.0 [Expression 2]
where ΔE₁,* represents a deviation of average color coordinates of a point A from average color coordinates of an arbitrary point B existing on the same axis, and
ΔE₂* represents a deviation of average color coordinates of a point A from average color coordinates of a point C which is present on a second axis having an average deviation of 75° to 105° from the first axis, is present on the same axis with the average color coordinates of the point A, and is spaced apart a distance of 3 cm or more from the point A.

2. The color-treated substrate according to claim 1, wherein
a deviation of a film average thickness of an arbitrary point A existing on the matrix including magnesium from a film average thickness of a point C existing on the second axis satisfies a condition of the following Expression 3:
10 nm≦|d₁-d₂| [Expression 3]
where d₁ represents a film average thickness of a point A, and d₂ represents a film average thickness of a point C.

3. The color-treated substrate according to claim 1, wherein an average thickness of the film is in a range of 50 nm to 2 μm.

4. The color-treated substrate according to claim 1, wherein the film includes magnesium hydroxide (Mg(OH)₂).

5. The color-treated substrate according to claim 1, wherein the matrix further includes stainless steel or titanium (Ti).

6. The color-treated substrate according to claim 1, further comprising:
a wavelength conversion layer formed on the film; and
a top coat formed on the wavelength conversion layer.

7. The color-treated substrate according to claim 6, wherein the wavelength conversion layer includes one or more selected from the group consisting of metals including aluminum (Al), chromium (Cr), titanium (Ti), gold (Au), molybdenum (Mo), silver (Ag), manganese (Mn), zirconium (Zr), palladium (Pd), platinum (Pt), cobalt (Co), cadmium (Cd) or copper (Cu) and ions thereof.

8. The color-treated substrate according to claim 6, wherein an average thickness of the wavelength conversion layer is in a range of 5 nm to 200 nm

9. A method of color-treating a substrate, comprising a step of immersing a matrix including magnesium in a hydroxide solution,
wherein the matrix immersed in the hydroxide solution includes:
an area having a first temperature (T₁); and
an area having a second temperature (T₂),
a difference between the first temperature (T₁) and the second temperature (T₂) is 5° C. or more.

10. The method according to claim 9, wherein the first temperature (T₁) and the second temperature (T₂) are each independently 95° C. or more.

11. The method according to claim 9, wherein the hydroxide solution includes one or more selected from the group consisting of NaOH, KOH, Mg(OH)₂, Ca(OH)₂ and Ba(OH)₂.

12. The method according to claim 11, wherein a concentration of the hydroxide solution is in a range of 1 to 80 wt % in the step of immersing in the hydroxide solution.

13. The method according to claim 9, wherein the step of immersing in the hydroxide solution includes:
a first immersion step of immersing in a hydroxide solution with a concentration of N₁; and
a n^{th} immersion step of immersing in a hydroxide solution with a concentration of Nₙ,
the concentration of the hydroxide solution in the first immersion step and the n^{th} step satisfies the following Expressions 3 and 4 independently of each other, and n is an integer of 2 or more and 6 or less:
8≦N₁≦25 [Expression 4]

|Nₙ₋₁-Nₙ|>3 [Expression 5]
where N₁ and Nₙ represent a concentration of a hydroxide solution in each step, and have units of wt %.

14. The method according to claim 9, further comprising one or more steps of:
pretreating a surface before the step of immersing in the hydroxide solution;
rinsing after the step of immersing in the hydroxide solution; and
forming a wavelength conversion layer after the step of immersing in the hydroxide solution.
